(19) United States
(12) Patent Application Publication
(10) Pub. No.: US 2020/0029149 A1
(43) Pub. Date: Jan. 23, 2020

(54) IN EAR STEREO HEADPHONES WITH INTEGRATED CHARGING MEANS

(71) Applicants: Nathan Nielsen, Herriman, UT (US); Joseph Nielsen, Herriman, UT (US)

(72) Inventors: Nathan Nielsen, Herriman, UT (US); Joseph Nielsen, Herriman, UT (US)

(21) Appl. No.: 16/037,490

(22) Filed: Jul. 17, 2018

(51) Int. Cl. H04R 1/10; H02J 7/02

(52) U.S. Cl. CPC H04R 1/1033; H04R 2420/09; H04R 1/1025; H02J 7/025

(57) ABSTRACT

Headphones are provided having one or more interwoven USB cables, Lightning® cables, and standard plugs, the headphones adapted to impart charging functionality to mobile computing devices. The headphones may also permit device to device data transmission. The headphones may also comprise an induction power transfer charger.

### FIELD OF THE INVENTION

This invention relates to headphones, and more particularly relates to in ear stereo headphones with adjustable volume controls and battery charging functionality.

### DESCRIPTION OF THE RELATED ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Headphones are well-known in the art, and generally include a pair of small loudspeakers that are designed to be held in place close to a user's ears. Headphones typically either have wires for connection to a signal source such as an audio amplifier, radio, CD player, portable media player or mobile phone, or have a wireless receiver. Typically, headphones in the art emit sound that is perceptible by humans at frequencies from about 20 Hz to 20,000 Hz.

Headphones heretofore devised and utilized are known to consist of an adjustable headband and a pair of earpieces coupled to the headband. Each of the earpieces has an open inner face which defines a cavity in the respective earpiece. Each earpiece may also have a generally circular shaped fabric covered shield covering the open inner face of the respective earpiece. The inner face of each of the earpieces has a center extent extending into the cavity of the respective earpiece. The center extent has a plurality of side faces each having at least one speaker mounted thereto.

Traditional headphones including cumbersome wires have not traditionally included integrated means for charging mobile phone batteries, despite both headphones and mobile phone batteries requiring elongated wiring.

Means of combining headphones and mobile tablet charging wires are unknown in the art, as are means of combining headphones and computer interconnection cables, such as USB cables or Apple® iPhone cables.

In view of the foregoing, it is clear that these traditional headphones are not optimal and leave room for more optimal approaches which integrate charging means and computer interconnection means. There is a need in the art for interactive headphones with integrated controls and memory. It is therefore desirable that such an apparatus and system be provided.

### SUMMARY OF THE INVENTION

From the foregoing discussion, it should be apparent that a need exists for in ear stereo headphones with integrated charging means. Beneficially, such an apparatus would overcome many of the difficulties with prior art by providing headphones with mobile battery charging capability and/or computer inconnectivity means.

The present invention has been developed in response to the present state of the art, and in particular, in response to the safety problems and needs in the art that have not yet been fully solved by currently available aparati. Accordingly, the present invention has been developed to provide a headphone set having integrating battery charging means, the headphones comprising: an audio signal cable affixed to male device connector; a standard electrical plug affixed to a first cable, wherein the audio signal cable and first cable are wound together within a single polymeric sheath ; a second standard plug affixed to a second cable, wherein the audio signal cable, first cable, and second cable are wound together within the single polymeric sheath; two earphones adapted to insert into a users ear, the earphones each comprising an audio transducer.

The first cable may be one of a USB cable and Lightning® cable (used by Apple Inc.). The second cable may be one of a USB cable and Lightning® cable (used by Apple Inc.).

The headphones may further comprise one or more headphone recesses adapted to receive and charge an inserted headbud.

The headphones may further comprise an induction power transfer charger.

A second headphone set having integrating battery charging means is provided, the headphones comprising: an audio signal cable affixed to male device connector; a USB plug affixed to a first USB cable, wherein the audio signal cable and USB cable are wound together within a single polymeric sheath; a micro USB plug affixed to a second USB cable, wherein the audio signal cable, first USB cable, and second USB cable are wound together within the single polymeric sheath; two earphones adapted to insert into a users ear, the earphones each comprising an audio transducer.

The second USB plug may be a standard-C USB plug. The first and second USB cables may be charge-only-cables.

The headphones may further comprise, in various embodiments, a polymeric cubic housing having spools for retracting the first USB cable and second USB cable. The headphones may further comprise one or more headphone recesses adapted to receive and charge an inserted headbud.

The headphones, in various embodiments, may further comprise an induction power transfer charger.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of in ear stereo headphones with integrated charging means in accordance with the present invention;

FIG. 2 is a forward side perspective view of in ear stereo headphones with integrated charging means in accordance with the present invention;

FIG. 3 is a forward top, side perspective view of an Apple® iPhone charging plug in accordance with the present invention; and

FIG. 4 is a side perspective view of in ear stereo headphones with integrated charging means in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

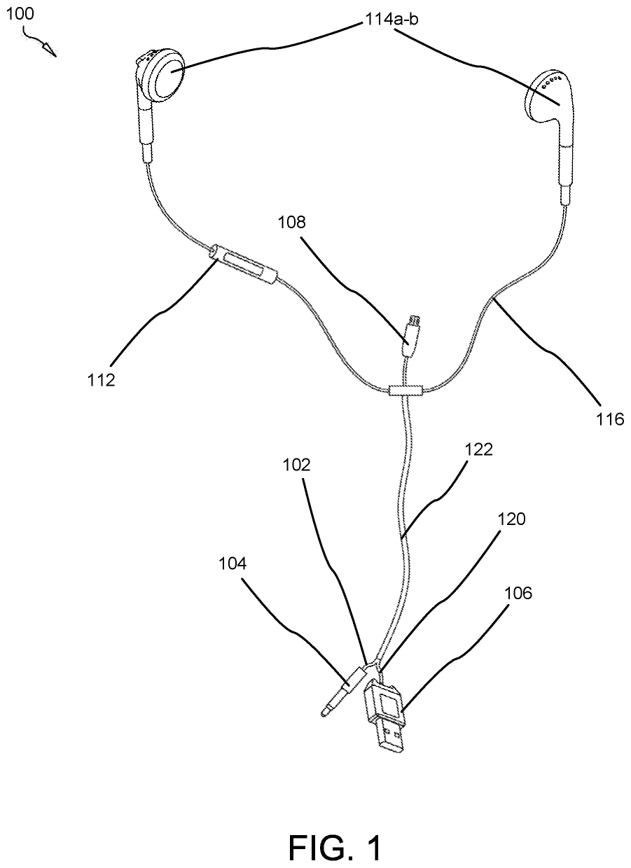

FIG. 1 is a side perspective view of in ear stereo headphones with integrated charging means 100 in accordance with the present invention. The headphones 100 comprise a speaker enclure 114a, a speaker enclosure 114b, an audio signal cable 102, a male device connector 104, a USB plug 106, a micro USB plug 108, and volume controls 112.

The padded earphones, or speaker enclosures 114, play audio emanating from any audio media player or any device, such a smart phone, outputting an audio signal, including compact disc players and MP3 players. The audio signal is carried on the audio signal cable 102.

The headphones 114 comprise, in the shown embodiment, in ear style speaker enclosures with detachable buds. The headphones 114 enclose one more audio output actuators, or audio transducers (i.e., speakers) for converting electrical input to audio.

In various embodiments, the headphones 114 comprise wireless headphones such as Apple® Airphones.

The proximal end of audio signal cable includes male device connector 104, which may comprise a 3.5 mm auxiliary audio cable commonly known to those of skill in the art.

The headphones 100 may comprise depressible buttons 112 which may control volume and which may be adapted to raise or lower volume of sound emitting or emanating from speakers within the earpieces 114a-b. In various embodiments, the depressible buttons 112 raise or lower resistance to electrical current flowing to the speakers.

The audio played by the headphones 100 may include formats originating in MP3, WAV, or other formats known to those of skill in the art.

The headphones 100 may comprise depressible power button adapted to activate, power on, the headphones 100.

The earphones 114 may comprise concave housings formed from polymeric, metallic, or metal alloys for receiving and housing a number of components, including a speaker, a middle balance ring, an aluminum ear cup, an ear cup plastic liner, and an ear cup plastic cover.

The headphones 100 comprise means for charging mobile phone batteries and may optionally comprise means for relaying and receiving electrical signals enabling device-to-device communication using the headphones 100 to interconnect the devices.

The headphones 100 comprise a USB plug 106 and may comprise a micro USB plug 108. The USB plugs 106, 108 insert into USB receptacles on adjoining devices.

The USB plug 106 is connected to a USB cable 120. The USB cable 120 travels with the audio signals cable 102. In various embodiments, the USB cable 120 and the audio signal cable 102 are interwoven within a nonconductive polymeric sheath 122. In other embodiments, the USB cable 120 and the audio signals cable 102 are bound together in the same polymeric sheath 122.

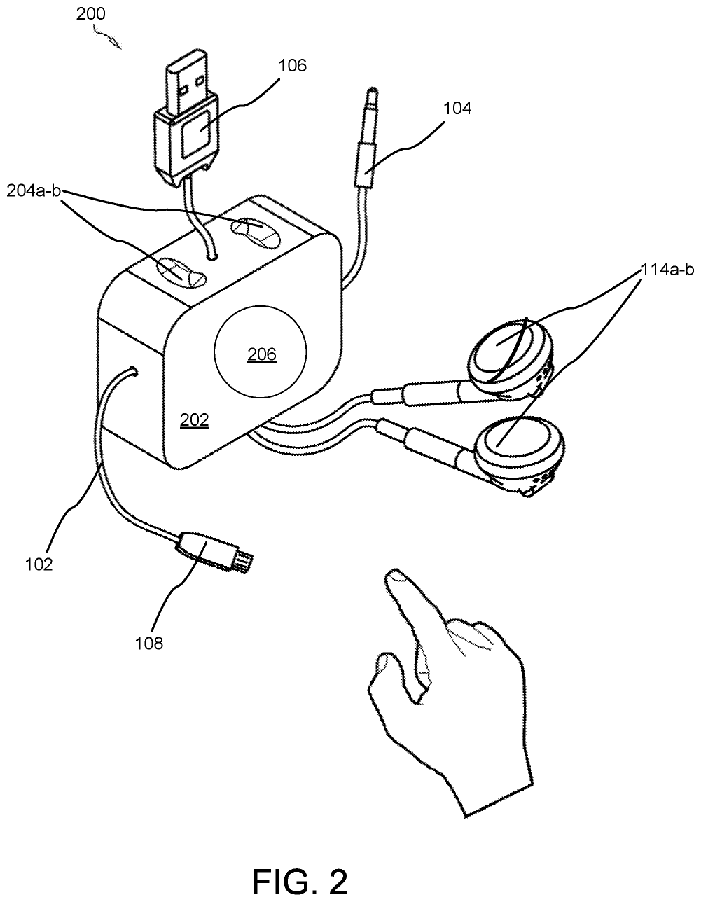

FIG. 2 is a forward side perspective view of in ear stereo headphones with integrated charging means 200 in accordance with the present invention.

The shown embodiment comprises a cubic housing unit 202 made of polymeric materials and spools for retracting the cable 102.

The headphones 200 may be configured to make use of the Bluetooth® protocols and procedures enabling device-to-device intercommunication connectivity. This functionality may be provided by incorporating the Bluetooth Intercom Profile® and/or the Bluetooth Telephony Profile®, or other wireless technologies known to those of skill in the art.

This communication may be in accordance with core specifications of one or more subsets of Bluetooth® profiles, wherein the core specifications comprise one or more of: the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

The headphones 200 may include one or more integrated charging ports and may include standard USB cable having a maximum length of 5 meters which is retractable in some embodiments. Connectors may include a receptable (female) and a plug (male). USB connector, including A-to-A connector, B-to-B and Y splitter cables. USB standard-A, standard-B or standard-C, charge only cable, a Lightning cable (used to charge Apple® iPhone and iPad charging cables), and the like.

The apparatus 200 may comprise charging recesses 204a-b for receiving and charging wireless headphones. The charging recesses 204 may configured to contour an outer surface of headphones 114 or headbuds.

The polymeric housing 102 includes wireless power transfer functionality for inductive charging of tablet DPDs 104. In various embodiments, the device 100 comprises a magnetic resonance (or inductive power transfer) unit 110 for charging a tablet DPD 104a sitting above the device 100.

In various other embodiments, the apparatus 200 comprises one or more magnetic resonance (or inductive power transfer) units 206 adapted to charge headphones through induction of a time-varying magnetic field in a transmitter coil using resonant (or magnetic) coupling. Current flowing within the apparatus 200 is converted into direct current by the receiver circuit within the headphones.

The apparatus 200 may also comprise a power supply 112, which is well-known to those of skill in the art.

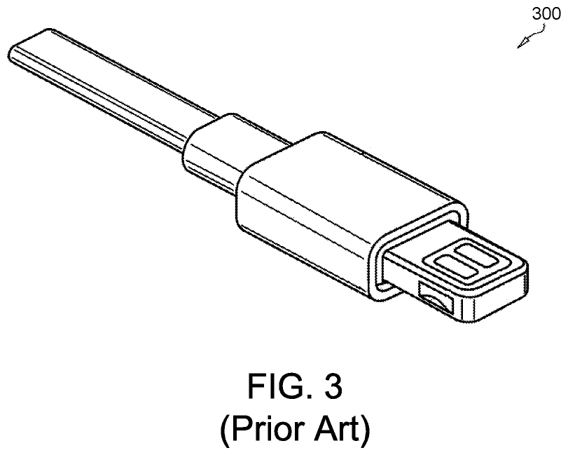

FIG. 3 is a forward top, side perspective view of an Apple® iPhone charging plug 300 in accordance with the pior art.

The apparti 100, 200 may comprise an Apple® iPhone charging plug 300 or any other standard plug known to those of skill in the art. The plug 300 may be in place of any USB, micro-USB, or mini-USB plug shown in the figures.

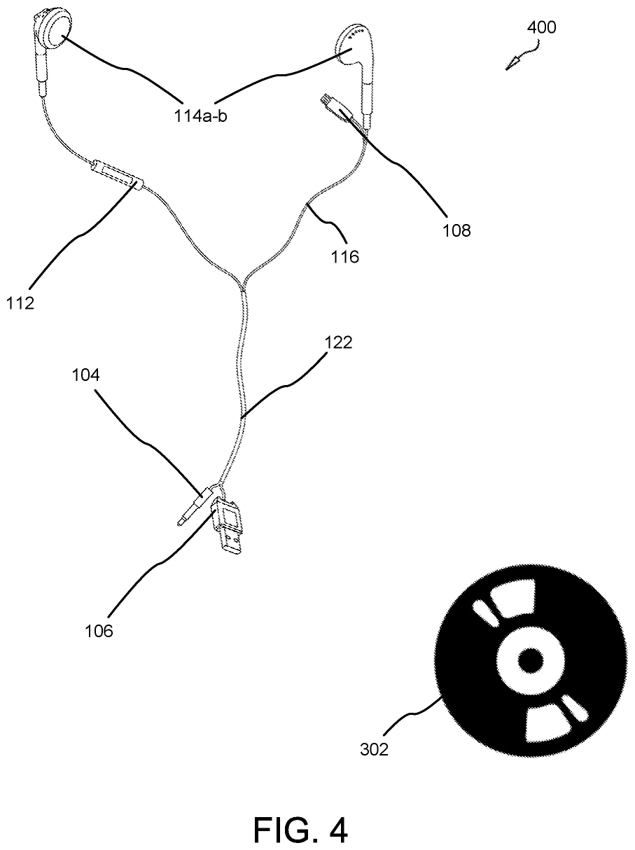

FIG. 4 is a side perspective view of in ear stereo headphones with integrated charging means 400 in accordance with the present invention.

In some embodiments, the USB plug 108 separates from the cable 102 at the earphone 114 from the cable 116 as shown.

The sheath 122 may terminate near the distal end of the apparatus 400. In these embodiments, the headphones 114 may be powered, requiring power from a USB or Lightning® plug to reach maximum volume. The auxiliary plug 104 and USB plug 106 may be affixed to cables extending between 0.5 inches and 5 inches of length before inserting into the sheath 122.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A headphone set having integrating battery charging means, the headphones comprising:
an audio signal cable affixed to male device connector;
a standard electrical plug affixed to a first cable, wherein the audio signal cable and first cable are wound together within a single polymeric sheet;
a second standard plug affixed to a second cable, wherein the audio signal cable, first cable, and second cable are wound together within the single polymeric sheath;
two earphones adapted to insert into a users ear, the earphones each comprising an audio transducer.

2. The headphones of claim 1, wherein the first cable is one a USB cable and Lightning® cable (used by Apple Inc.).

3. The headphones of claim 1, wherein the second cable is one a USB cable and Lightning® cable (used by Apple Inc.).

4. The headphones of claim 1, further comprising one or more headphone recesses adapted to receive and charge an inserted headbud.

5. The headphones of claim 1, further comprising an induction power transfer charger.

6. A headphone set having integrating battery charging means, the headphones comprising:
an audio signal cable affixed to male device connector;
a USB plug affixed to a first USB cable, wherein the audio signal cable and USB cable are wound together within a single polymeric sheath;
a micro USB plug affixed to a second USB cable, wherein the audio signal cable, first USB cable, and second USB cable are wound together within the single polymeric sheath;
two earphones adapted to insert into a users ear, the earphones each comprising an audio transducer.

7. The headphones of claim 6, wherein the second USB plug is a standard-C USB plug.

8. The headphones of claim 6, wherein the first and second USB cables are charge only cables.

9. The headphones of claim 6, further comprising a polymeric cubic housing having spools for retracting the first USB cable and second USB cable.

10. The headphones of claim 6, further comprising one or more headphone recesses adapted to receive and charge an inserted headbud.

11. The headphones of claim 6, further comprising an induction power transfer charger.
